(19) United States
(12) Patent Application Publication
(10) Pub. No.: US 2026/0178413 A1
(43) Pub. Date: Jun. 25, 2026

(54) APPLICATION SCHEDULAR

(71) Applicant: International Business Machines Corporation, Armonk, NY (US)

(72) Inventors: Sivas SRR, Bangalore (IN); Sarbajit Kumar Rakshit, Kolkata (IN); Bharath S, Bangalore (IN); Neil Delima, Scarborough (CA)

(21) Appl. No.: 18/991,961

(22) Filed: Dec. 23, 2024

(51) Int. Cl. G06F 9/50

(52) U.S. Cl. CPC G06F 9/5055; G06F 2209/501; G06F 2209/503

(57) ABSTRACT

A computer-implemented method identifies a set of system applications of a system and a set of resources. A composite performance score is determined for each of the resources and the resources are ranked. The system applications are classified in at least two classifications such that each system application corresponds to a single classification and the classifications include a hierarchy of importance. The resources are ranked based on the composite scores. A highest ranked available resource is scheduled to an unscheduled system application having the highest classification of unscheduled system applications as a primary resource. A next highest ranked available resource is scheduled to the unscheduled system application as a secondary resource. The ranking and scheduling is reiterated until all system applications have been assigned to a resource. A schedule of resources identifying each system application and each resource scheduled to the system applications is output.

### BACKGROUND

The present invention generally relates to scheduling system applications to resources, and more specifically, to a computer implemented system for scheduling system applications to resources based on a reliability score of the resources.

Systems, such as industrial systems, scheduling systems, transaction systems and the like utilize substantial numbers of components operating simultaneously to achieve completion of an end task. Each of the components utilizes resources to perform the designated functions of the component. In some systems, multiple components may utilize overlapping resources and the components are scheduled to resources in order to ensure that any given resource is not overutilized and that all components are assigned to sufficient resources at any given time.

### SUMMARY

Embodiments of the present invention are directed to a computer-implemented method for scheduling system applications within a system to resources. A non-limiting example of the computer-implemented method includes a computer-implemented method identifies a set of system applications of a system and a set of resources. A composite performance score is determined for the resources in the set of resources and the resources are ranked using the composite scores. The system applications are classified in the set of system applications in at least two classifications such that each system application corresponds to a single classification and the classifications include a hierarchy of importance. The resources are ranked based on the composite scores. A highest ranked available resource is scheduled to an unscheduled system application having the highest classification of unscheduled system applications as a primary resource. A next highest ranked available resource is scheduled to the unscheduled system application as a secondary resource. The ranking and scheduling is reiterated until all system applications have been assigned to a resource. A schedule of resources identifying each system application and each resource scheduled to the system applications is output.

Embodiments of the present invention are further directed to a system and a method for the same.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2 depicts a scheduling architecture for assigning system applications to resources; and

FIG. 3 depicts a process for utilizing the architecture of FIG. 2 to assign system applications to resources.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as scheduling applications to resources at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 132. Public Cloud 105 includes gateway 130, Cloud orchestration module 141, host physical machine set 142, virtual machine set 143, and container set 144.

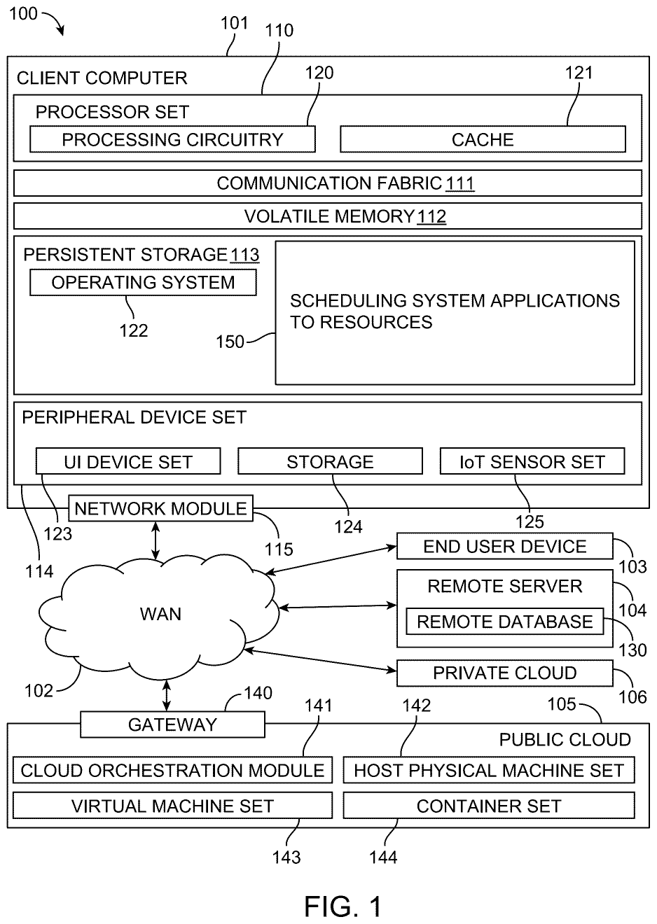

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 141. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

As used herein “system applications” refers to components and functions of an overall system that independently or semi-independently operate to further the overall function of the system. System applications can include physical hardware, computer applications, and combinations thereof. System applications utilize resources, including infrastructure, of the system to achieve their operations. In one example, system applications can include computer applications operating cooperatively to determine an output, control a vehicle, or perform any similar function. In another example system applications can include applications operating a supervisory control and data acquisition system (SCADA system) for power generation, oil and gas industries, or any similar system. In another example, system applications can include a combination of software applications, transaction resources, and databases which form a ticketing and scheduling service, such as for airline ticketing. In yet another example, system applications can include manufacturing lines, robots, and inventory tracking software. The example system applications described herein are illustrative in nature and do not limit the scope of system applications.

As used herein “resources” refers to any features, structures, infrastructure, consumables or other aspects of a system that are utilized by system applications to perform a corresponding function. By way of example, in a computing system, a resource can include time, calculations, processing power, memory storage, and the like. Similarly, in an industrial setting, a resource can include system infrastructure such as manufacturing lines and individual robotic systems, as well as raw materials and computational resources.

Turning now to an overview of technologies that are more specifically relevant to aspects of the invention, system applications include all applications that are used to perform everyday operations of a given system. The system operations can include database transactions, user interfaces, outputs, and the like. For any given system certain system applications are essential to continued operation, while other system applications may be temporarily shut down without substantially impacting performance of the overall system. A system application is essential if continued operation of the system relies on continued operation of the essential system application.

Essential system applications that use specific resources should be made to be highly reliable in order to avoid inadvertent shutdowns of the system. Thus, it is desirable to schedule essential system applications to best behaving (e.g., most reliable) resources and provide a backup resource scheduling in the event that the resource(s) supporting an essential system application loses functionality. Exacerbating the difficulty of this scheduling is the fact that which system applications are essential may vary depending on external conditions. By way of example, production scheduling may require certain system applications to be online at an end of a production cycle, when quotas are required to be met, but not online at the beginning of a production cycle when maintenance or other operations may be prioritized. Thus, the related system applications are essential at one point in time and not essential at another point in time.

Given the disparate types of system applications and resources on which those system applications are operated, as well as the fact that which system applications are essential may vary depending on conditions, scheduling the system applications to resources in a manner that ensures continued availability of the essential system applications without overusing any given resource is difficult.

Turning now to an overview of the aspects of the invention, one or more embodiments of the invention address the above-described shortcomings of the prior art by providing a process for scheduling essential system applications to best performing resources based on a historical performance of the system application and provide a heterogeneous backup and constant monitoring. Using the constant monitoring, the scheduling is updated as more performance data is accrued.

Scheduling the essential system applications efficiently aids in maximizing resource utilizing and ensures optimal performance of the system. By approaching scheduling using a process that identifies a best resource for each system application based on historical performance data and providing a full backup schedule for all essential system applications, the robustness and flexibility of the system application scheduling is improved relative to existing scheduling processes.

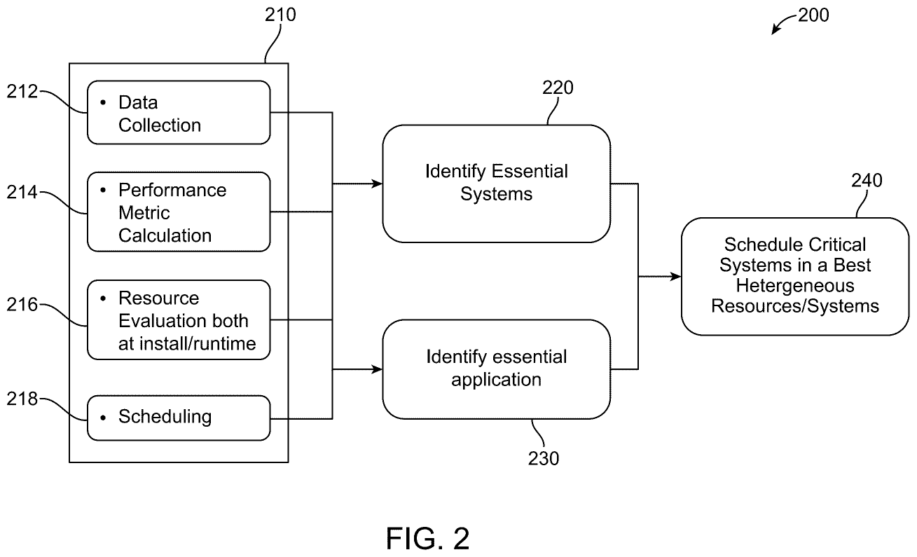

With continued reference to FIG. 1, FIG. 2 illustrates an architecture 200 for a resource scheduling process. The architecture 200 includes a system model 210 that defines the system including the system applications that are being scheduled to resources. The system model 210 includes a data collection module 212, a performance metric calculation module 214, a resource evaluation module 216 and a historical scheduling module 218. Using the model 210, the architecture 200 identifies composite performance scores of each system application using a composite score module 220, and identifies essential system applications using an essential system application module 230.

In some examples, system applications may neatly divide into “essential” and “non-essential” categories due to interdependency of the system applications. In such examples, the essential system application module 230 ranks the relative importance of each system application, thereby allowing the more important system applications to receive priority scheduling of resources.

Outputs of both the composite performance score module 220 and the essential system application module 230 are provided to a scheduling module 240 that schedules the system applications to resources in a determined best manner.

In one example of the architecture 200, the module 210 collects data including execution time of the system application, resource utilization, error rates, throughput and latency for each system application. For each resource, the performance metric calculation module determines an average execution time (AET), an average resource utilization (ARU), an error rate (ER), an average latency (AL), and an average throughput (TP) over the time period that the data is collected. The resource evaluation module 216 checks for the existence of a heterogeneous backup for each system application and evaluates the performance of any identified heterogeneous backups. The scheduled module 218 ranks the infrastructure, selects a best infrastructure for each system application and provides dynamic adjustment (e.g. adjustment based on external conditions) to the rankings.

The performance metrics are calculated using predefined metric formulas and applying the data from the data collection module 212. In one example, and with like variables indicating like quantities, the average execution time is calculated according to:

$$A {E}_{T i} = \frac{1}{n} {\sum }_{j = 1}^{n} Execution {Time}_{ij} ,$$

where n is the number of tasks executed by a resource Ri, i is the system application, and j is an arbitrary constant integer;
the average resource utilization (ARU) is calculated according to:

$$ARUi = 1 / n {\sum }_{j = 1}^{n} Resource Utilization ij ;$$

the error rate (ER) is calculated according to:

$$E R i = \frac{Number of Errors i}{Total Tasks i} ;$$

and
the throughput (TP) is calculated according to:

$$T P i = \frac{ToTal Tasks i}{ToTal Time i}$$

The composite score module 220 evaluates and ranks the resources available by defining a composite score of each resource. The composite score is a weighted combination of each of the performance metrics identified by the performance metric module 214, with the weighting of each metric being set by a system designer and a heavier weighting indicating a greater level of importance of the particular metric. In one example, the composite score is a simple weighted sum according to:

CPSi=w1(1/AETi)+w2(1/ARUi)+w3(1/ERi)+w4 (TPi)+w5(1/ALi), with w1, w2, w3, w4, and w5 being weighting values assigned to each metric. As can be appreciated, the higher the weighting value, the more important the metric is considered to be when determining the reliability of a resource.

When ordering resources by composite score with a higher score occurring earlier in the list, the earlier a composite score occurs in the list the more reliable the resource is considered to be.

The essential system application module 230 analyzes the data of past operations, and the historical scheduling and identifies which system applications are essential during a given set of conditions and which system applications are non-essential. In further examples, the system applications can be ranked in order of importance, rather than discretely classified as “essential” and “non-essential”. In yet further examples, a designer may manually select which system applications are essential in a given context, with the selection being based on the designer's understanding of the system and the designer's understanding of similar or related systems.

Once the composite scores are calculated by the composite score module 220 and the essential system applications are identified, or the system applications are ranked by how important they are, in the essential system application module 230, the architecture 200 schedules the essential system applications to the best resources using a scheduling module 240. The scheduling module 240 uses the outputs of both the essential system application module 230 and the essential system applications module 230 to generate a primary schedule that assigns system applications to resources assuming all resources are available and to generate at least one backup resource for each system application.

By including the backup resource(s), when a resource is unavailable, the system application utilizing that resource may switch to a second resource as the backup resource. Any lower priority system applications that were relying on the second resource may change to their backup resource in a cascading fashion. In this way, all the essential system applications have a backup resource available, even if that resource is scheduled to another system application during normal operations.

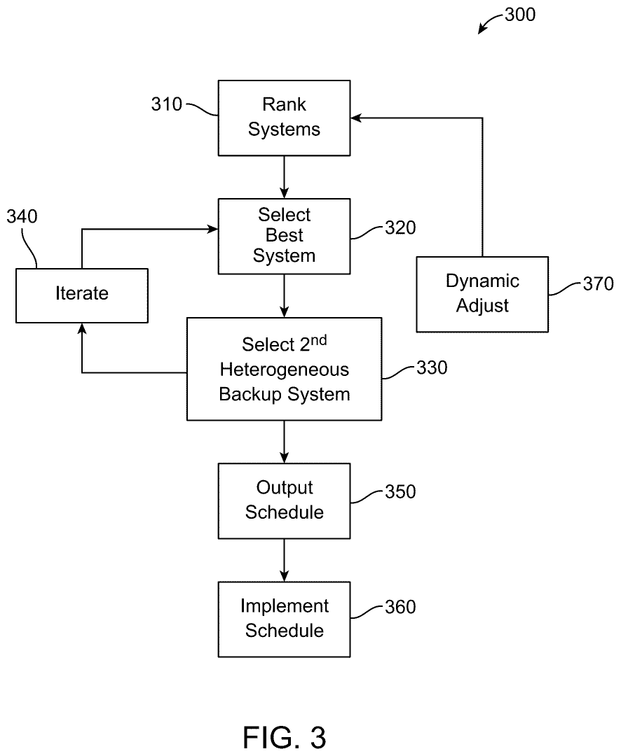

With continued reference to FIG. 2, FIG. 3 illustrates a process 300 for scheduling the resources to system applications according to one example. In an initial ranking step 310, the resources are ranked in descending order according to the determine composite score. Based on the determined ranking, the highest ranking resource is scheduled to the most important system application that can use the resource in a select best resource step 320. The next usable resource, in descending order determined by the ranking, is assigned to the most important system application as a second (backup) resource in a select second resource step 330.

The selection steps 320, 330 are iterated for each sequential system application in order of importance via an iteration step 340. When the system applications are discretely divided into essential and non-essential system applications, the selection steps 320, 330 are applied to the essential system applications first in an arbitrary order then applied to non-essential system applications. In yet other examples, where multiple categories (e.g., highest priority, second highest priority and lowest priority) each contain multiple system applications, the selection steps 320, 330 are applied to each category in order of most important category to least important category in the same manner as the discrete “essential”/“non-essential” division.

In some examples, where the capacity of some resources is not fully used by one system application, such a resource may be assigned to one or more addition system applications until the capacity of the resource is reached.

Once every system application is scheduled to corresponding resources, the process 300 outputs the schedule in an output step 350, and the system implements the schedule in an implement step 360.

In some examples, such as a system where the system applications are computer processes, and the resources are processing time, processors, and the like, the implementation can take the form of automatically adjusting which resource is applied to which system application in a configuration file and engaging the adjustments.

In other examples, where the implementation takes the form of physical connections to resources (e.g. electrical connections, supply lines, etc.) the implementation can take the form of providing connection instructions, transmitting the resource schedule to a technician, or any similar implementation.

In other examples, where the implementation is a hybrid of physical resources and digital resources, a hybrid of both implementations may be utilized.

In order to achieve robustness, the process 300 further includes a dynamic adjustment step 370. When triggered, the dynamic adjustment step 370 causes the process 300 to re-rank the resources 310 including any new data within the model 210, as well as any seasonal factors or other conditions that may alter the importance of one or more system application and/or alter the rankings of the resources.

The once the resource ranking is adjusted, using the same rank resources step 310, the process 300 proceeds as above, and maintains until the dynamic adjustment step 370 is triggered again.

One example system where the architecture 200 and process 300 of FIGS. 2-3 could be implemented is within a ticketing system, such as for airline ticketing. Ticketing systems can be subject to cascading errors, where an outage in one (or a few) critical system applications can result in a failure of the entire system. By way of example, when system applications controlling check-in (for example) are inaccessible, tickets cannot be used, re-booking tickets and/or refunding tickets cannot be performed, etc. Thus, the check-in system application is an essential system application. The architecture and process described herein provides a catalog of available resources, including their composite performance score and schedules the most reliable resource to the critical system applications including the check-in system application.

When an outage occurs, the scheduler is immediately able to identify the next best resource to utilize for operating the check-in system based on the timely calculated composite performance score. The scheduler then switches the check-in system applications to the backup resources, and switches all less important system applications in the cascading fashion.

Utilization of the process and methods described herein facilitate identification of the best resource and the second best resource for each system application, based on composite performance scores, and provides a scheduled backup resource as well as a cascading framework for reassigning system applications to resources as resources become unavailable due to being down or being rescheduled.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
identifying a set of system applications of a system and a set of resources;
determining a composite performance score for the resources in the set of resources and ranking the resources in the set of resources using the composite scores;
classifying the system applications in the set of system applications in at least two classifications such that each system application corresponds to a single classification, and wherein the classifications include a hierarchy of importance;
ranking the resources in the set of resources based on the composite scores;
scheduling a highest ranked available resource to an unscheduled system application having the highest classification of unscheduled system applications as a primary resource and scheduling a next highest ranked available resource to the unscheduled system application as a secondary resource;
reiterating scheduling the highest ranked available resource to the unscheduled system application having the highest classification of unscheduled system applications and scheduling a next highest ranked available resource to the unscheduled system application as a secondary resource until all system applications have been assigned to a resource; and
outputting a schedule of resources identifying each system application and each resource scheduled to the system applications.

2. The computer-implemented method of claim 1, further comprising automatically implementing at least scheduled resource using the schedule of resources.

3. The computer-implemented method of claim 1, wherein the composite performance score of a resource of the set of resources is a combination of an average execution time (AET), an average resource utilization (ARU), an error rate (ER), an average latency (AL), and an average throughput (TP) over a time period of the resource of the set of resources.

4. The computer-implemented method of claim 3, wherein the composite performance score is a weighted sum combination of the average execution time (AET), the average resource utilization (ARU), the error rate (ER), the average latency (AL), and the average throughput (TP) over a time period of the resource of the set of resources.

5. The computer-implemented method of claim 1, further comprising responding to a dynamic adjustment request by reiterating:
determining the composite performance score for the resources in the set of resources and ranking the resources in the set of resources using the composite scores;
classifying the system applications in the set of system applications in at least two classifications such that each system application corresponds to the single classification, and wherein the classifications include a hierarchy of importance;
ranking the resources in the set of resources based on the composite scores;
scheduling the highest ranked available resource to the unscheduled system application having the highest classification of unscheduled system applications as the primary resource and scheduling a next highest ranked available resource to the unscheduled system application as the secondary resource;
reiterating scheduling the highest ranked available resource to the unscheduled system application having the highest classification of unscheduled system applications and scheduling the next highest ranked available resource to the unscheduled system application as the secondary resource until all system applications have been assigned to the resource; and
outputting a schedule of resources identifying each system application and each resource scheduled to the system applications.

6. The computer-implemented method of claim 1, wherein in at least two classifications includes an essential classification and a non-essential classification, the essential classification being a highest priority in the hierarchy of importance.

7. The computer-implemented method of claim 6, wherein the at least two classifications includes at least a third classification and wherein the third classification is between the essential classification and the non-essential classification in the hierarchy of importance.

8. The computer-implemented method of claim 1, wherein the at least two classifications includes a number of classifications equal to a number of system applications.

9. The computer-implemented method of claim 1, wherein the set of system applications comprises computer software applications and the set of resources comprises computer processing resources.

10. A system comprising:
a client computer having processor set and a persistent storage, wherein the persistent storage stores an application scheduling module, and wherein the application scheduling module is configured to cause the processor to:
identify a set of system applications of a system and a set of resources;
determine a composite performance score for the resources in the set of resources and ranking the resources in the set of resources using the composite scores;
classify the system applications in the set of system applications in at least two classifications such that each system application corresponds to a single classification, and wherein the classifications include a hierarchy of importance;
rank the resources in the set of resources based on the composite scores;
schedule a highest ranked available resource to an unscheduled system application having the highest classification of unscheduled system applications as a primary resource and scheduling a next highest ranked available resource to the unscheduled system application as a secondary resource;
reiterate scheduling the highest ranked available resource to the unscheduled system application having the highest classification of unscheduled system applications and scheduling a next highest ranked available resource to the unscheduled system application as a secondary resource until all system applications have been assigned to a resource; and
output a schedule of resources identifying each system application and each resource scheduled to the system applications.

11. The system of claim 10, further comprising automatically implementing at least scheduled resource using the schedule of resources.

12. The system of claim 10, wherein the composite performance score of a resource of the set of resources is a combination of an average execution time (AET), an average resource utilization (ARU), an error rate (ER), an average latency (AL), and an average throughput (TP) over a time period of the resource of the set of resources.

13. The system of claim 10, wherein the composite performance score is a weighted sum combination of an average execution time (AET), an average resource utilization (ARU), an error rate (ER), an average latency (AL), and an average throughput (TP) over a time period of the resource of the set of resources.

14. The system of claim 10, further comprising responding to a dynamic adjustment request by reiterating:
determining the composite performance score for the resources in the set of resources and ranking the resources in the set of resources using the composite scores;
classifying the system applications in the set of system applications in at least two classifications such that each system application corresponds to the single classification, and wherein the classifications include a hierarchy of importance;
ranking the resources in the set of resources based on the composite scores;
scheduling the highest ranked available resource to the unscheduled system application having the highest classification of unscheduled system applications as the primary resource and scheduling a next highest ranked available resource to the unscheduled system application as the secondary resource;
reiterating scheduling the highest ranked available resource to the unscheduled system application having the highest classification of unscheduled system applications and scheduling the next highest ranked available resource to the unscheduled system application as the secondary resource until all system applications have been assigned to the resource; and
outputting a schedule of resources identifying each system application and each resource scheduled to the system applications.

15. The system of claim 10, wherein in at least two classifications includes an essential classification and a non-essential classification, the essential classification being a highest priority in the hierarchy of importance.

16. The system of claim 15, wherein the at least two classifications includes at least a third classification and wherein the third classification is between the essential classification and the non-essential classification in the hierarchy of importance.

17. The system of claim 10, wherein the at least two classifications includes a number of classifications equal to a number of system applications.

18. The system of claim 10, wherein the set of system applications comprises computer software applications and the set of resources comprises computer processing resources.

19. A method comprising:
identifying a set of system applications of a system and a set of resources;
determining a composite performance score for the resources in the set of resources and ranking the resources in the set of resources using the composite scores;
classifying the system applications in the set of system applications in at least two classifications such that each system application corresponds to a single classification, and wherein the classifications include a hierarchy of importance;
ranking the resources in the set of resources based on the composite scores;
scheduling a highest ranked available resource to an unscheduled system application having the highest classification of unscheduled system applications as a primary resource and scheduling a next highest ranked available resource to the unscheduled system application as a secondary resource;
reiterating scheduling the highest ranked available resource to the unscheduled system application having the highest classification of unscheduled system applications and scheduling a next highest ranked available resource to the unscheduled system application as a secondary resource until all system applications have been assigned to a resource; and
outputting a schedule of resources identifying each system application and each resource scheduled to the system applications.

20. The method of claim 19, further comprising further comprising responding to a dynamic adjustment request by reiterating:
determining the composite performance score for the resources in the set of resources and ranking the resources in the set of resources using the composite scores;
classifying the system applications in the set of system applications in at least two classifications such that each system application corresponds to the single classification, and wherein the classifications include a hierarchy of importance;
ranking the resources in the set of resources based on the composite scores;
scheduling the highest ranked available resource to the unscheduled system application having the highest classification of unscheduled system applications as the primary resource and scheduling a next highest ranked available resource to the unscheduled system application as the secondary resource;
reiterating scheduling the highest ranked available resource to the unscheduled system application having the highest classification of unscheduled system applications and scheduling the next highest ranked available resource to the unscheduled system application as the secondary resource until all system applications have been assigned to the resource; and
outputting a schedule of resources identifying each system application and each resource scheduled to the system applications.
